(19) United States
(12) Patent Application Publication
(10) Pub. No.: US 2004/0255116 A1
(43) Pub. Date: Dec. 16, 2004

(54) Electronic document management system with the use of signature technique capable of masking

(76) Inventors: Shingo Hane, Yokohama (JP); Takahiro Fujishiro, Yokohama (JP); Tadashi Kaji, Fujisawa (JP); Yoko Kumagai, Tokyo (JP); Junichi Takeuchi, Yokohama (JP)

Correspondence Address: MCDERMOTT, WILL & EMERY, 600 13th Street, N.W., Washington, DC, 20005-3096, US

(21) Appl. No.: 10/644,064

(22) Filed: Aug. 20, 2003

(30) Foreign Application Priority Data
Jun. 6, 2003 (JP) 2003-161505

(51) Int. Cl. H04L 9/00

(52) U.S. Cl. 713/161

(57) ABSTRACT

The present invention provides a technology for verifying the validity of an electronic document by using a signature affixed to the electronic document at the time of its creation even if the electronic document is partially rendered private at the time of its disclosure. An target electronic document is divided into two or more partial documents having an arbitrary or fixed length. This division is effected by using a tag of XML or other markup language so as to provide versatility or by adding a dedicated delimiter for division. The system has a signature function. The signature function uses a signature technique for generating the information for verifying the validity of each of the partial documents, and validating a signature affixed to the electronic document to confirm the validity of the whole electronic document by affixing a signature to the aggregate of the generated validity confirmation information.

### INCORPORATION BY REFERENCE

This application claims priority based on a Japanese patent application, No. 2003-161505 filed on Jun. 6, 2003, the entire contents of which are incorporated herein by reference.

### BACKGROUND OF THE INVENTION

The present invention relates to a document management system based on a digital signature technique and digital signature verification technique.

The public key encryption technology uses a set of two keys. The information encrypted with one of such keys can be decrypted with the other key. In this instance, the information cannot be decrypted with the key used for encryption and can only be decrypted with the remaining key. When the public key encryption technology is adopted, one of these two keys is secretly stored as a private key and used for the generation of a digital signature (hereinafter abbreviated to a signature) and for decryption. The remaining key is released as a public key and used for signature verification and encryption.

When a public key cryptography system is used for signatures, SHA-1 or other algorithm-based hash function is first used to derive a digest value (or a characteristics value), called a hash value, from the electronic document targeted for a signature. Next, the obtained hash value is encrypted with the private key for use as a signature value.

For signature verification, the signature value is decrypted with the public key and restored to a hash value for the electronic document. The electronic document's hash value is then calculated and compared against the restored hash value. If the electronic document is not altered, these two hash values coincide with each other. If, on the other hand, the electronic document is altered, the hash value derived from the electronic document is changed so that the two hash values differ from each other. When these steps are performed, the electronic document can be checked to determine whether it is altered.

A typical application of the above public key use for a signature is an XML (extensible Markup Language) signature. The XML signature itself is similar to a signature based on the conventional technology because the digest value of target data is determined and encrypted with a private key. With this XML signature method, it is possible to affix signatures to data divisions by using an XML tag. This method also makes it possible to affix a partial signature or multiple signature to data. In marked contrast to the aforementioned signature method, which affixes only one signature to all data, the XML signature method permits complicated signature application.

Another signature method is a division signature method. The division signature method divides the target electronic document and affixes a signature to each of the resulting divisions. For a conventional signature method of this type (refer, for instance, to Japanese Patent Laid-open No. 2001-167086, hereinafter Patent Document 1), there is a description of how to sign and store data divisions. Since this division signature method affixes a signature to each data division, it makes it possible to reference and edit the data on an individual division basis.

When, for instance, a public organization discloses a paper document containing privacy-related information to the public in compliance with a request for information disclosure, a masking process is performed, for instance, to black out the privacy-related portion, thereby making the document partially private. Document data contained in an electronic document (which may be hereinafter simply referred to as a document) can also be disclosed to the public except for privacy-related information. However, if a signature is affixed to a document designated by a request for public disclosure, a problem arises. If a document previously signed for privacy protection is partially masked, the resulting document is regarded as an altered document so that the previously affixed signature is no longer valid. The reason is that the document's hash value is changed by masking and is now in disagreement with the hash value certified by the signature.

The above problem can be solved by applying a resigning method or the aforementioned division signature method.

When the resigning method is adopted, a signature is affixed again to a masked electronic document for approving any alteration. However, this method invalidates the signature that was affixed at the time of document creation, and causes a problem if the person who affixed a signature to the created document differs from the person who masks the document. Another problem also arises because two different signature times are involved.

When data signed by the division signature method described by Patent Document 1 is masked, the signature affixed to the masked division becomes invalid, but the signatures affixed to the remaining unmasked divisions are valid so that verification is successful. However, no affixed signatures assure the validity of the whole data prevailing before masking. Consequently, if, for instance, the sequence of data divisions is changed, a problem arises because such a change cannot be detected by means of signature verification.

### SUMMARY OF THE INVENTION

The present invention provides a technology for verifying the validity of an electronic document by using a signature affixed to the electronic document at the time of its creation even if the electronic document is partially rendered private at the time of its disclosure.

An electronic document targeted for a signature is divided into two or more partial documents having an arbitrary or fixed length. This division is effected by using a tag of XML or other markup language so as to provide versatility or by adding a dedicated delimiter for division. The system has a signature function. The signature function uses a signature technique for generating the information for verifying the validity of each of the partial documents, and validating a signature affixed to the electronic document to confirm the validity of the whole electronic document by affixing a signature to the aggregate of the generated validity confirmation information.

The system also has a masking function. The masking function partially conceals (masks) the electronic document, which is signed by the above signature function, by deleting or modifying the electronic document on an individual partial document basis. Each partial document is referred to as a unit of masking.

Further, the system has a verification function, which is used to verify the validity of an electronic document that is signed by the above signature function. The verification function confirms the validity of the whole electronic document by verifying the signature affixed to the aggregate of the validity confirmation information, and compares respective validity confirmation information contained in the aggregate against the validity confirmation information generated from partial documents. If the former information is the same as the latter, the verification function causes the system to confirm that the electronic document is not partially altered. If, on the other hand, the former information differs from the latter, the verification function causes the system to confirm that the electronic document is partially concealed (masked).

As the information for validity confirmation described above, either a hash value that is generated from a partial document (a unit of masking) by using a hash function or a signature affixed to a partial document can be used.

More specifically, the system of the present invention comprises, in one of its aspects, a data creation device for creating unmasked data by dividing an electronic document into partial documents; a signature device for creating, from the partial documents, signature-related data which comprises validity confirmation information and a signature for the aggregate of such information; a masking device for creating masked data by performing a masking operation, that is, deleting or modifying one or more partial documents; and a verification device which incorporates a verification function and data display function. The verification function of the verification device confirms the validity of the electronic document by verifying the unmasked data or masked data with the signature-related data. The data display function of the verification device displays the unmasked data or masked data, the signature-related data, and the verification result.

The present invention is capable of masking signed electronic documents, which are placed under management, by partially concealing or modifying them, certifying their validity, and detecting masked portions.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a system configuration diagram of a signed electronic document management system according to one embodiment.

FIG. 2 illustrates unmasked data 2 and signature-related data 4 according to one embodiment.

FIG. 3 illustrates masked data 6 according to one embodiment.

FIG. 4 illustrates a flowchart that illustrates the operations of the data creation unit 21 in the data creation device 11 according to one embodiment.

FIG. 5 illustrates a flowchart that illustrates the operations of the display unit 22 in the data creation device 11 according to one embodiment.

FIG. 6 illustrates a flowchart that illustrates the operations of the signature unit 23 in the signature device 12 according to one embodiment.

FIG. 7 illustrates a flowchart that illustrates the operations of the signature verification unit 24 in the signature device 12, the signature verification unit 27 in the masking device 13, and the verification unit 30 in the verification device 14 in accordance with one embodiment.

FIG. 8 illustrates a flowchart that illustrates the operations of the display unit 25 in the signature device 12, the display unit 28 in the masking device 13, and the display unit 29 in the verification device 14 in accordance with one embodiment.

FIG. 9 illustrates a flowchart that illustrates the operations of the masking unit 26 in the masking device 13 according to one embodiment.

FIG. 10 illustrates a typical use of a signed electronic document management system according to one embodiment.

### DETAILED DESCRIPTION OF THE EMBODIMENTS

Embodiments of the present invention will now be described with reference to the accompanying drawings.

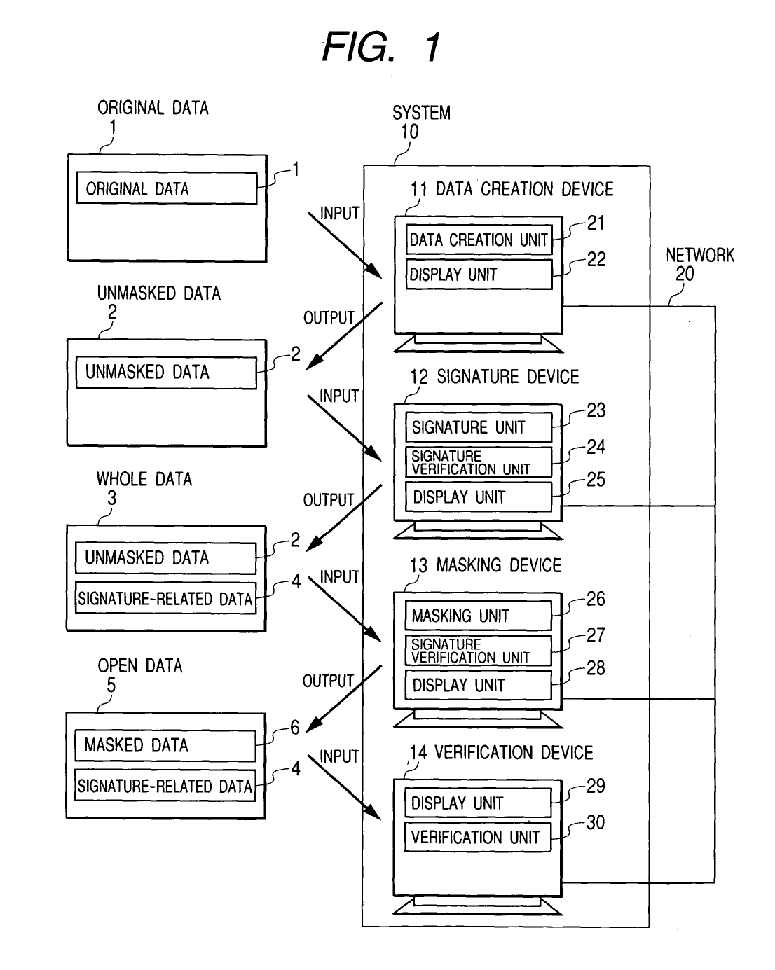

FIG. 1 is an overall configuration diagram of an electronic document management system 10 based on a signature technique capable of masking according to one embodiment of the present invention.

As shown in FIG. 1, the system 10, which is based on a signature technique capable of masking, comprises four components connected by a network 20. The first component is a data creation device 11, which comprises a data creation unit 21 and a data display unit 22. The data creation unit 21 has a data creation function for creating unmasked data 2 from original data 1. The created unmasked data can be masked even after a signature. The data display unit 22 has a data display function for displaying unmasked data 2.

The second component is a signature device 12, which comprises a signature unit 23, a signature verification unit 24, and a display unit 25. The signature unit 23 has a signature function for signing unmasked data 2 to create signature-related data 4. The signature verification unit 24 has a signature verification function for verifying unmasked data 2 with the signature-related data 4 to confirm the validity of the data. The display unit 25 has a data display function for displaying unmasked data 2 and signature-related data 4 together with the result of signature verification.

The third component is a masking device 13, which comprises a masking unit 26, a signature verification unit 27, and a display unit 28. The masking unit 26 has a masking function for masking unmasked data 2 or masked data 6 by partially deleting or modifying it for the purpose of creating new masked data 6. The signature verification unit 27 has a signature verification function for verifying unmasked data 2 or masked data 6 with the signature-related data 4 for the purpose of confirming the data validity. The data display unit 28 has a data display function for displaying unmasked data 2 or masked data 6, signature-related data 4, and the result of signature verification.

The fourth component is a verification device 14, which comprises a data display unit 29 and a verification unit 30. The data display unit 29 has a data display function for displaying unmasked data 2 or masked data 6, signature-related data 4, and the result of signature verification. The verification unit 30 has a verification function for verifying unmasked data 2 or masked data 6 with the signature-related data 4 for the purpose of confirming the data validity.

The above data creation device 11, signature device 12, masking device 13, and verification device 14 are implemented in the form of a common computer, which is capable of running application software on basic software (also known as an operating system), equipped at least with a microprocessor, a secondary storage device such as a hard disk, a memory, input devices such as a keyboard and a mouse, and a display device, and provided as needed with a GPU or like processor and a removable storage media read/write device or a network interface or like input/output device.

The data creation device 11 can use an application running on the basic software in order to create, edit, and convert data in a data format that can be signed by a signature technique capable of masking. The data creation device 11 edits or creates original data 1, converts it to unmasked data 2, which is in a format that permits masking after a signature, and displays the resulting unmasked data. The data creation unit 21 within the data creation device 11 is used for data editing and creation, whereas the display unit 22 is used to display information as needed for such data editing and creation. The data handled by the data creation device 11 is read and saved as needed by exercising a secondary storage device/removable storage media access function provided by the basic software. Further, a network 20 is used to exchange data with the signature device 12.

The signature device 12 can use an application running on the basic software in order to affix a signature with a signature technique capable of masking. The signature device 12 creates signature-related data 4 by signing unmasked data 2, which is created by the data creation device 11, then combines the unmasked data 2 and signature-related data 4 to create the whole data 3, and, if necessary, performs signature verification. The signature unit 23 within the signature device 12 is used to sign data, whereas the signature verification unit 24 performs signature verification. Further, the display unit 25 is used to display a signature and the result of verification. The data handled by the signature device 12 is read and saved as needed by exercising a secondary storage device access function provided by the basic software. Further, the network 20 is used to exchange data with the data creation device 11 and masking device 13.

The masking device 13 can use an application running on the basic software in order to mask the information to be rendered private for the purpose of disclosing data that is signed by a signature technique capable of masking. The masking device 13 creates masked data 6 by masking the relevant parts of unmasked data 2 within the whole data 3, which is created by the signature device 12, then creates and displays open data 5 by combining the masked data 6 and signature-related data 4, and, if necessary, performs signature verification. The masking unit 26 within the masking device 13 is used to perform a masking operation, whereas the signature verification unit 27 is used to perform signature verification. Further, the display unit 28 is used to display the information about masking and the result of verification. The data handled by the masking device 13 is read and saved as needed by exercising a secondary storage device access function provided by the basic software. Further, the network 20 is used to exchange data with the signature device 13 and verification device 14.

The verification device 14 can use an application running on the basic software in order to display masked, open data for confirmation purposes. The verification device 14 displays the open data 5, which is created by the masking device 13, after signature verification. The data handled by the verification device 14 is read and saved as needed by exercising a secondary storage device access function provided by the basic software. Further, the network 20 is used to exchange data with the masking device 13.

The processes described below are performed on the component devices 11 through 14 when the microprocessor reads and executes one or more programs stored on the aforementioned hard disk or in memory under the basic software's management.

The programs may be stored beforehand in the memory of the above computer or entered as needed into the memory via a removable storage medium or communication medium (a communication line or a carrier wave on a communication line) available to the computer.

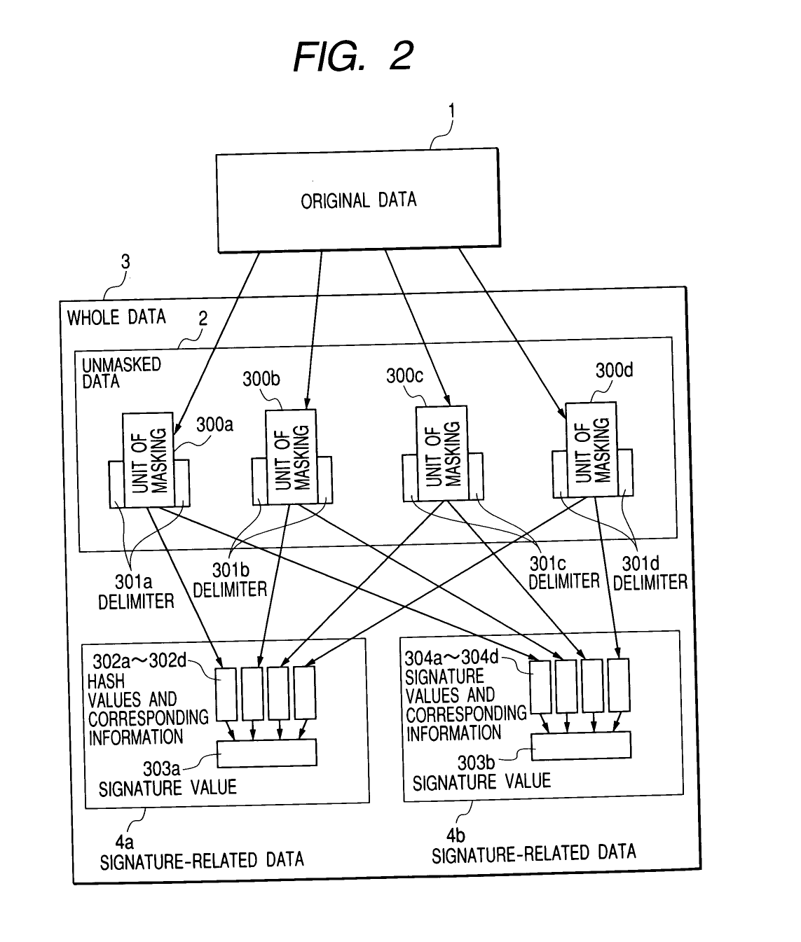

FIG. 2 shows the details of unmasked data 2 and signature-related data 4 that are handled by the system. Original data 1, which is maskable and targeted for a signature, is arbitrary document data. When the original data 1 is to be converted to unmasked data 2, the original data 1 is divided into a plurality of units of masking 300. Although FIG. 2 indicates that the original data 1 is divided into four units of masking 300a through 300d, it can be divided at any positions and into any number of divisions. To show the relationship between the divisions and signature data, delimiters 301a through 301d are created and added to the beginning and end or either the beginning or end of the units of masking 300.

A series of units of masking 300 and delimiters 301 is saved as unmasked data 2. When the unmasked data 2 is to be signed in such a manner that it can be masked, two signature-related data creation methods are selectable: one is for creating signature-related data 4a and the other is for creating signature-related data 4b.

Signature-related data 4a can be created by obtaining the hash values and corresponding information 302a through 302d for the units of masking 300a through 300d, which compose the unmasked data 2, and determining signature value 303a for their aggregate. On the other hand, signature-related data 4b can be created by obtaining the signature values and corresponding information 304a through 304d for the units of masking 300a through 300d, which compose the unmasked data 2, and determining signature value 303b for their aggregate. The unmasked data 2 and signature-related data 4a or the unmasked data 2 and signature-related data 4b are combined and saved as the whole data 3.

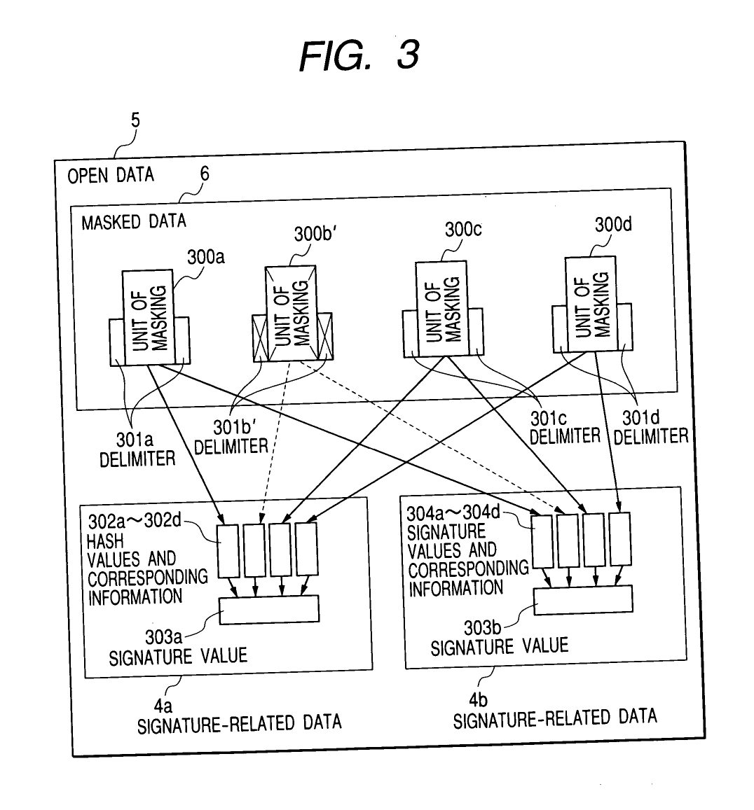

FIG. 3 shows the details of masked data 6 that is handled by the system. The masked data 6 is created by applying data deletion or modification to the “to be masked” portion of the units of masking 300a-300d of unmasked data 2 within the whole data 3. As an example, unit of masking 300b is changed to unit of masking 300b′. The masked data 6 is saved together with the signature-related data 4 as open data 5.

For signature verification, signature-related data 4a or 4b is used. First, the signature having signature value 303a or 303b is checked for verification. If the verification is not successful, it is concluded that the unmasked data 2 or masked data 6 targeted for a signature is wholly changed. If the signature having signature value 303a or 303b is successfully verified, on the other hand, a hash value and corresponding information 302 or a signature value and corresponding information 304 are used to check each unit of masking 300 for verification. When a hash value and corresponding information 302 are used for verification, the hash value for the corresponding unit of masking 300 is compared against the hash value for the hash value and corresponding information 302. If the compared values are the same, verification is successful. If not, verification is not successful. When a signature value and corresponding information 304 are used for verification, the associated unit of masking 300 is checked for verification with the signature value for the signature value and corresponding information 302. If the unit of masking 300 is successfully verified, it means that the document has not been altered since it was signed. If, on the other hand, the unit of masking 300 is not successfully verified, it means that the unit of masking 300 has been masked or altered.

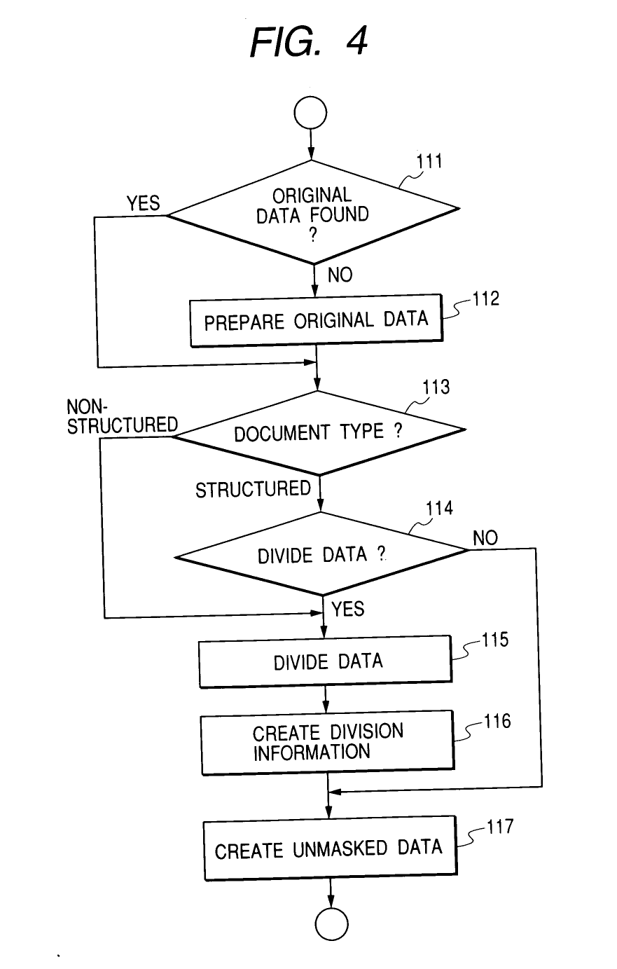

FIG. 4 is a flowchart illustrating the operations of the data creation unit 21, which is used by the data creation device 11. The operation performed in each step will now be described. However, it should be noted that data can be saved and read with the network 20 or an input/output device at any time in any step.

Step 111 is performed to check for the original data 1, which is used by the data creation unit 21. When the original data is found, the control flow proceeds to step 113. If no original data is found, the control flow proceeds to step 112 in order to create or edit data.

Step 112 is performed to prepare the original data 1 for unmasked data 2, which can be signed in a format that permits masking. Alternatively, data can entered from the outside and used as the original data 1. After the original data 1 is created, the control flow proceeds to step 113.

Step 113 is performed to check the data format of the original data. If the original data is markup language or other similarly structured data, the control flow proceeds to step 114. If not, the control flow proceeds to step 115.

Since markup language or other similarly structured data can be directly used as unmasked data 2 while markup structuring tags as delimiters, further division may not always be required. Step 114 is therefore performed to determine whether or not to divide the data into small units of masking 300. If such a division is to be made, the control flow proceeds to step 115. If no such division is required, the data creation unit 21 terminates its process.

Step 115 is performed so as to divide the original data 1 into small units of masking 300. The control flow then proceeds to step 116. As a division method, either the fixed-length or variable-length type can be chosen.

In step 116, markup language tags or other delimiting data are used to create division information in order to indicate the divisions of the original data 1, which is divided into units of masking 300. Upon completion of division information creation, the control flow proceeds to step 117.

In step 117, the division information is inserted into the original data 1 to create unmasked data 2. All the steps to be performed by the data creation unit 21 are now completed.

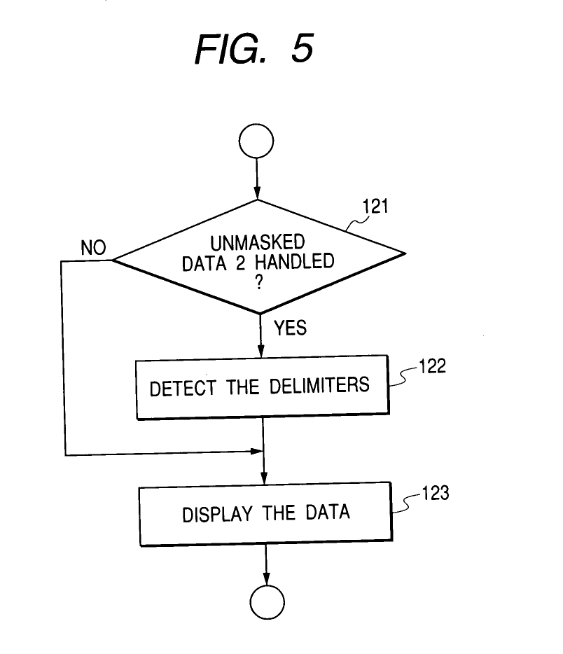

FIG. 5 is a flowchart illustrating the operations of the display unit 22 that is used by the data creation device 11. The operation performed in each step will now be described. However, it should be noted that data can be saved and read with the network 20 or an input/output device at any time in any step.

Step 121 is performed to check whether the original data 1 or unmasked data 2 is to be displayed. If the unmasked data 2 is to be displayed, the control flow proceeds to step 122. If the original data 1 is to be displayed instead of the unmasked data 2, the control flow proceeds to step 123.

Step 122 is performed to detect delimiters for the unmasked data 2 to be displayed. Upon delimiter detection, the control flow proceeds to step 123.

Step 123 is performed to visibly delimit the units of masking 300 of the original data 1 and display the unmasked data 2 or masked data 6. All the steps to be performed by the display unit 22 are now completed.

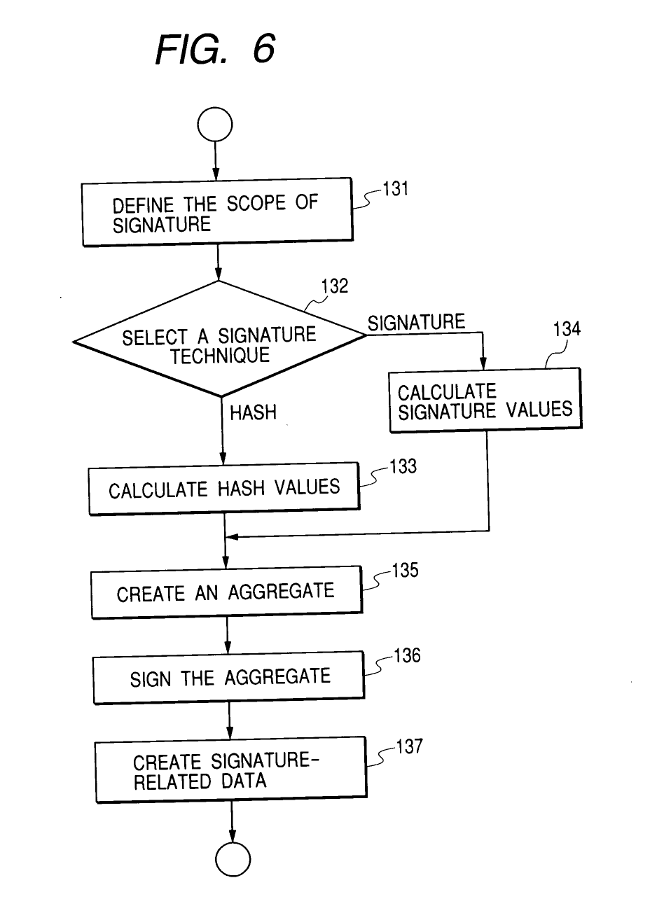

FIG. 6 is a flowchart illustrating the operations of the signature unit 23, which is used by the signature device 12. The operation performed in each step will now be described. However, it should be noted that data can be saved and read with the network 20 or an input/output device at any time in any step.

Step 131 is performed to define the scope of signing the unmasked data 2 by selecting a division delimited by one or more delimiters (hereinafter referred to as a unit of masking 300).

Step 132 is performed to select a signature technique for the scope that was selected in step 131. Two different signature techniques are selectable: one is for determining only the hash value for each unit of masking 300 and the other is for signing each unit of masking 300. If the hash value is to be determined, the control flow proceeds to step 133. If, on the other hand, a signature operation is to be performed, the control flow proceeds to step 134.

Step 133 is performed to determine the hash values for all the units of masking 300 within the scope that was selected in step 131. Upon completion of this step, the control flow proceeds to step 135.

Step 134 is performed to sign all the units of masking 300 within the scope that was selected in step 131 and then determine the signature values. Upon completion of signature value determination, the control flow proceeds to step 135.

Step 135 is performed to create the aggregate of the hash values or signature values determined in step 133 or 134. Upon completion of aggregate creation, the control flow proceeds to step 136.

Step 136 is performed to sign the aggregate that was created in step 135.

Step 137 is performed to create signature-related data 4, which contains the aggregate determined in step 135 as well as the signature value determined in step 136. The unmasked data 2 and signature-related data 4 are then combined and stored as the whole data 3. All the steps to be performed by the signature unit 23 are now completed.

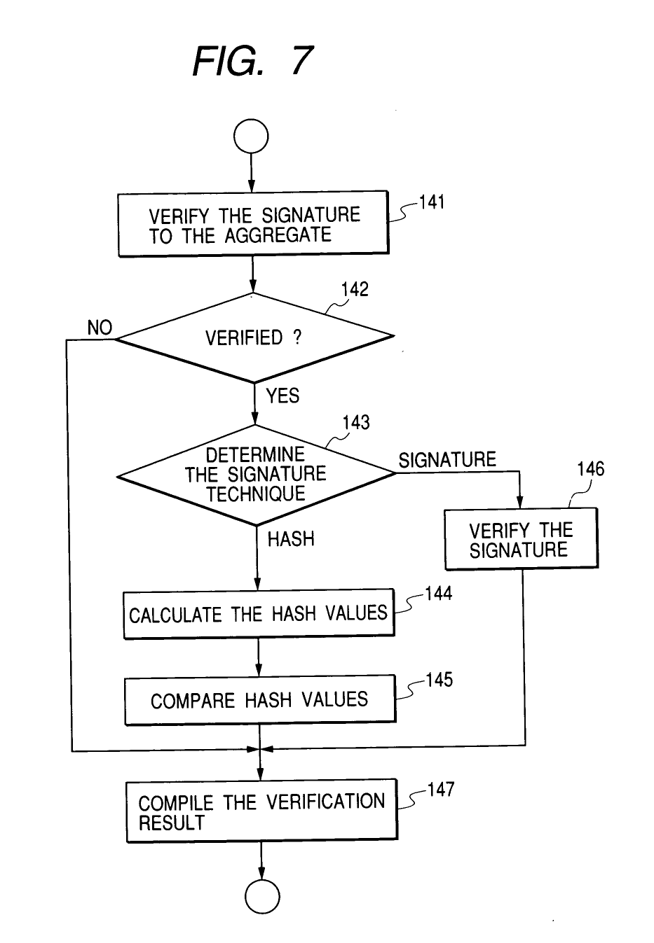

The operations of the signature verification unit 24 in the signature device 12 will now be described with reference to a flowchart shown in FIG. 7. Although the operation performed in each step will be described below, it should be noted that data can be saved and read with the network 20 or an input/output device at any time in any step.

Step 141 is performed to verify the signature to the aggregate of hash values or signal values in the signature-related data 4, which is contained in the whole data 3 or open data 5. If signature verification is successful, the validity of the aggregate of hash values or signature values is certified so that the unmasked data 2 contained in the whole data 3 can be verified. If, on the other hand, signature verification is unsuccessful, the validity of the unmasked data 2 cannot be certified because the validity of the aggregate of hash values or signature values cannot be certified. Upon completion of the verification step, the control flow proceeds to step 142.

Step 142 is conducted to check whether signature verification was successfully performed in step 141. If signature verification was successful, the control flow proceeds to step 143. If signature verification was unsuccessful, however, the control flow proceeds to step 147.

Step 143 is performed to check the signature-related data 4 to determine whether the employed signature technique for the unit of masking 300 uses the hash value or affixes a signature. If the hash value is to be used, the control flow proceeds to step 144. If a signature is to be affixed, the control flow proceeds to step 146.

Step 144 is performed to determine the hash values for all the units of masking 300 of the unmasked data 2 as is the case with step 133. Upon completion of this step, the control flow proceeds to step 145.

Step 145 is performed to verify the unit of masking 300 by comparing the hash value certified by signature verification in step 142 against the hash value determined in step 144. If these two hash values are equal, the validity is certified because the corresponding unit of masking 300 is neither masked nor altered. If, on the other hand, the two hash values are not equal, it means that the corresponding unit of masking 300 is masked or altered. Upon completion of this verification step, the control flow proceeds to step 147.

In step 146, the signature value certified by signature verification in step 142 is used to perform signature verification for each corresponding hash. If signature verification is successful, the validity is certified because the corresponding unit of masking 300 is neither masked nor altered. If, on the other hand, signature verification is unsuccessful, the corresponding unit of masking 300 is masked or altered. Upon completion of this verification step, the control flow proceeds to step 147.

Step 147 is performed to compile the result of verification of the unit of masking 300 performed in step 145 or 146.

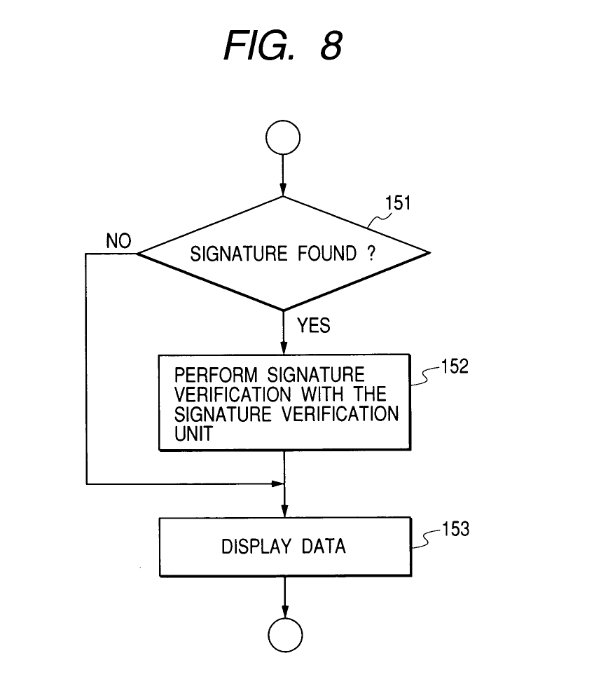

The operations of the display unit 25 in the signature device 12 will be described with reference to a flowchart in FIG. 8. Although the operation performed in each step will be described below, it should be noted that data can be saved and read with the network 20 or an input/output device at any time in any step.

In step 151, the unmasked data 2 to be displayed is checked for signature-related data for the purpose of determining whether a signature has been affixed. If a signature has been affixed, the control flow proceeds to step 152. If no such signature has been affixed, the control flow proceeds to step 153.

In step 152, the signature verification unit 24 is used to perform signature verification for the purpose of verifying the signature to the unmasked data 2 to be displayed, and then obtain the result of signature verification. Upon completion of this step, the control flow proceeds to step 153.

Step 153 is performed to display the unmasked data 2 with the units of masking 300 of the original data 1 visibly delimited and with the display color visually changed to indicate a portion where signature verification has been successful. All the steps to be performed by the display unit 25 are now completed.

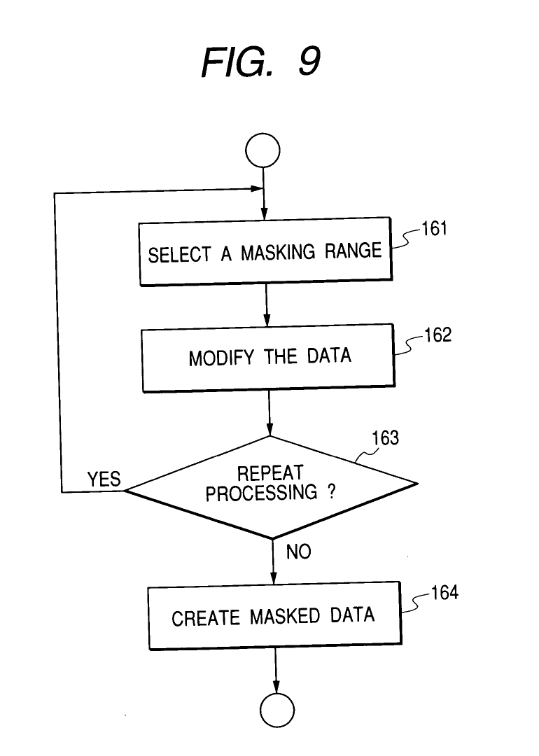

FIG. 9 is a flowchart illustrating the operations of the masking unit 26, which is used by the masking device 13. The operation performed in each step will now be described. However, it should be noted that data can be saved and read with the network 20 or an input/output device at any time in any step.

Step 161 is performed to select the units of masking 300 to be masked, which are within the unmasked data 2 contained in the whole data 3. Upon completion of this step, the control flow proceeds to step 162.

Step 162 is performed to mask the range selected in step 161 by modifying or concealing it. Masking can be achieved by deleting the selected data; however, the data can alternatively be replaced with data indicating that masking is done. Upon completion of this step, the control flow proceeds to step 163.

Step 163 is performed to determine whether or not to repeat steps 161 and 162. If another unit of masking 300 is to be masked in addition to the unit of masking 300 that was masked in step 162, the option of repeating the processing steps is chosen so that the control flow returns to step 161. If no more units of masking 300 are to be masked, the control flow proceeds to step 164.

In step 164, masked data 6 is created in such a manner as to reflect the units of masking 600 that were masked in the preceding steps. The masked data 6 and signature-related data 4 are then combined and stored as open data 5. All the steps to be performed by the masking unit 26 are now completed.

The operations of the signature verification unit 27 in the masking device 13 will now be described with reference to a flowchart in FIG. 7. Although the operation performed in each step will be described below, it should be noted that data can be saved and read with the network 20 or an input/output device at any time in any step.

Step 141 is performed to verify the signature to the aggregate of hash values or signal values in the signature-related data 4, which is contained in the whole data 3 or open data 5. If signature verification is successful, the validity of the aggregate of hash values or signature values is certified so that the unmasked data 2 within the whole data 3 or the masked data 6 within the open data 5 can be verified. If, on the other hand, signature verification is unsuccessful, the validity of the unmasked data 2 or masked data 6 cannot be certified because the validity of the aggregate of hash values or signature values cannot be certified. Upon completion of the verification step, the control flow proceeds to step 142.

Step 142 is conducted to check whether signature verification was successfully performed in step 141. If signature verification was successful, the control flow proceeds to step 143. If signature verification was unsuccessful, however, the control flow proceeds to step 147.

Step 143 is performed to check the signature-related data 4 to determine whether the employed signature technique for the unit of masking 300 uses the hash value or affixes a signature. If the hash value is to be used, the control flow proceeds to step 144. If a signature is to be affixed, the control flow proceeds to step 146.

Step 144 is performed to determine the hash values for all the units of masking 300 of the unmasked data 2 or masked data 6 as is the case with step 133. Upon completion of this step, the control flow proceeds to step 145.

Step 145 is performed to verify the unit of masking 300 by comparing the hash value certified by signature verification in step 142 against the hash value determined in step 144. If these two hash values are equal, the validity is certified because the corresponding unit of masking 300 is neither masked nor altered. If, on the other hand, the two hash values are not equal, it means that the corresponding unit of masking 300 is masked or altered. Upon completion of this verification step, the control flow proceeds to step 147.

In step 146, the signature value certified by signature verification in step 142 is used to perform signature verification for each corresponding hash. If signature verification is successful, the validity is certified because the corresponding unit of masking 300 is neither masked nor altered. If, on the other hand, signature verification is unsuccessful, the corresponding unit of masking 300 is masked or altered. Upon completion of this verification step, the control flow proceeds to step 147.

Step 147 is performed to compile the result of verification of the unit of masking 300 performed in step 145 or 146.

The operations of the display unit 28 in the masking device 13 will now be described with reference to a flowchart in FIG. 8. Although the operation performed in each step will be described below, it should be noted that data can be saved and read with the network 20 or an input/output device at any time in any step.

Step 151 is performed to check the signature-related data 4 for the unmasked data 2 within the whole data 3 to be displayed or the signature-related data 4 for the masked data 6 within the open data 5 to be displayed for the purpose of determining whether a signature has been affixed. If a signature has been affixed, the control flow proceeds to step 152. If no such signature has been affixed, the control flow proceeds to step 153.

In step 152, the signature verification unit 27 is used to perform signature verification for the purpose of verifying the signature to the unmasked data 2 within the whole data 3 to be displayed or the masked data 6 within the open data 5 to be displayed and then obtain the result of signature verification. Upon completion of this step, the control flow proceeds to step 153.

Step 153 is performed to display the unmasked data 2 within the whole data 3 or the masked data 6 within the open data 5 with the units of masking 300 of the original data 1 visibly delimited and with the display color visually changed to indicate a portion where signature verification has been successful as well as a masked portion. All the steps to be performed by the display unit 28 are now completed.

The operations of the verification unit 30 in the verification device 14 will now be described with reference to a flowchart in FIG. 7. Although the operation performed in each step will be described below, it should be noted that data can be saved and read with the network 20 or an input/output device at any time in any step.

Step 141 is performed to verify the signature to the aggregate of hash values or signal values in the signature-related data 4, which is contained in the open data 5. If signature verification is successful, the validity of the aggregate of hash values or signature values is certified so that the masked data 6 contained in the whole data 3 or open data 5 can be verified. If, on the other hand, signature verification is unsuccessful, the validity of the masked data 6 cannot be certified because the validity of the aggregate of hash values or signature values cannot be certified. Upon completion of this verification step, the control flow proceeds to step 142.

Step 142 is conducted to check whether signature verification was successfully performed in step 141. If signature verification was successful, the control flow proceeds to step 143. If signature verification was unsuccessful, however, the control flow proceeds to step 147.

Step 143 is performed to check the signature-related data 4 to determine whether the employed signature technique for the unit of masking 300 uses the hash value or affixes a signature. If the hash value is to be used, the control flow proceeds to step 144. If a signature is to be affixed, the control flow proceeds to step 146.

Step 144 is performed to determine the hash values for all the units of masking 300 of the masked data 6 as is the case with step 133. Upon completion of this step, the control flow proceeds to step 145.

Step 145 is performed to verify the unit of masking 300 by comparing the hash value certified by signature verification in step 142 against the hash value determined in step 144. If these two hash values are equal, the validity is certified because the corresponding unit of masking 300 is neither masked nor altered. If, on the other hand, the two hash values are not equal, it means that the corresponding unit of masking 300 is masked or altered. Upon completion of this verification step, the control flow proceeds to step 147.

In step 146, the signature value certified by signature verification in step 142 is used to perform signature verification for each corresponding hash. If signature verification is successful, the validity is certified because the corresponding unit of masking 300 is neither masked nor altered. If, on the other hand, signature verification is unsuccessful, the corresponding unit of masking 300 is masked or altered. Upon completion of this verification step, the control flow proceeds to step 147.

Step 147 is performed to compile the result of verification of the unit of masking 300 performed in step 145 or 146.

The operations of the display unit 29 in the verification device 14 will now be described with reference to a flowchart in FIG. 8. Although the operation performed in each step will be described below, it should be noted that data can be saved and read with the network 20 or an input/output device at any time in any step.

Step 151 is performed to check the signature-related data for the masked data 6 to be displayed for the purpose of determining whether a signature has been affixed. If a signature has been affixed, the control flow proceeds to step 152. If no such signature has been affixed, the control flow proceeds to step 153.

In step 152, the verification unit 30 is used to perform signature verification for the purpose of verifying the signature to the masked data 6 to be displayed and then obtain the result of signature verification. Upon completion of this step, the control flow proceeds to step 153.

Step 153 is performed to display the masked data 6 with the units of masking 300 of the original data 1 visibly delimited and with the display color visually changed, if a signature is affixed, to indicate a portion where signature verification has been successful as well as a masked portion. All the steps to be performed by the display unit 29 are now completed.

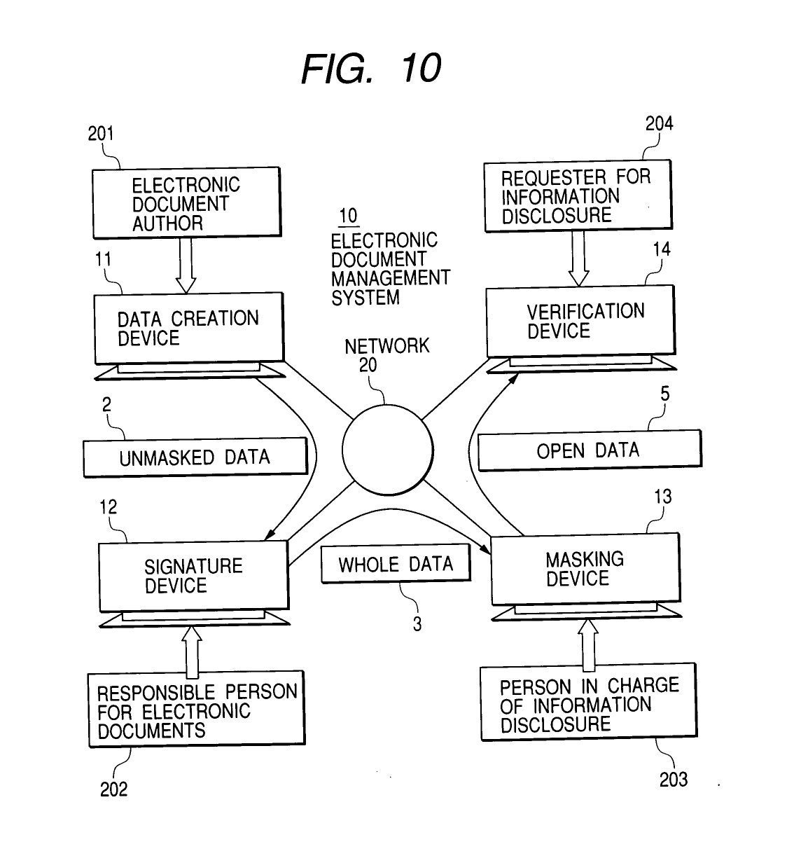

As described above, the system of the present embodiment is capable of masking a part of an electronic document while an affixed signature remains effective and identifying such a masked part. With this feature, it is possible to solve problems that may arise when a signed document is to be disclosed. In the electronic document management system 10 shown in FIG. 10, an electronic document author 201, who belongs to a public institution, creates unmasked data 2 with the data creation device 11, saves it, and delivers it to the responsible person for electronic documents 202 via the network 20. The responsible person for electronic documents 202, who has the power to control within the public institution, uses the signature device 12 to affix a signature to the unmasked data 2 by applying such a signature technique as to permit signing after masking, and then stores the data as whole data 3. When a public requester for information disclosure makes a request for the disclosure of the stored whole data 3 according to the Freedom of Information Act and the whole data 3 needs to be masked (partially concealed) for privacy protection or like purposes, the person in charge of information disclosure at the public institution uses the masking device 13 to read the stored whole data 3 via the network 20, create open data 5 by masking relevant portions, and disclose the open data 5 to the requester for information disclosure 204 via the network 20. The requester for information disclosure 204 receives the open data 5, displays it on the verification device 14, and confirms its contents.

The configuration of the electronic document management system 10 according to the present embodiment is not limited to that is described in conjunction with the foregoing embodiment. An alternative configuration is such that the individual processing units of the system components are implemented as separate devices and interconnected via a network.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. An electronic document management system, comprising:
a data creation device for creating data by dividing an electronic document into two or more partial documents having an arbitrary or fixed length;
a signature device for generating a plurality of items of information for verifying the validity of each of the partial documents and affixing a digital signature to an aggregate of the generated items of information for verifying the validity of the partial documents;
a masking device for masking, by deleting or modifying, the electronic document targeted for a digital signature on an individual partial document basis; and
a verification device for verifying the validity of the masked electronic document.

2. The electronic document management system according to claim 1, wherein the verification device confirms the validity of the whole electronic document by verifying the aggregate of the information for confirming the validity of the partial documents; and confirms the validity of the partial documents of the electronic document targeted for verification by verifying the information for confirming the validity of each of the partial documents, and determines whether the electronic document is partially deleted or modified.

3. The electronic document management system according to claim 2, wherein the verification device displays the result of the verification on a display unit for the purpose of notifying a verifier whether the electronic document is partially deleted or modified while assuring the validity of the whole electronic document.

4. The electronic document management system according to claim 1, wherein the data creation device divides the electronic document by adding a delimiter to the beginning and/or end of the partial documents.

5. The electronic document management system according to claim 4, wherein the electronic document is a document created with a markup language, wherein the partial documents are markup units for the document created with the markup language, and wherein the delimiter is a tag for the markup language.

6. The electronic document management system according to claim 2, wherein the information for confirming the validity of the partial documents is a hash value which is generated with a hash function for the partial documents.

7. The electronic document management system according to claim 2, wherein the information for confirming the validity of the partial documents is a digital signature for the partial documents.
